(19) United States
(12) Patent Application Publication
(10) Pub. No.: US 2025/0070289 A1
(43) Pub. Date: Feb. 27, 2025

(54) BATTERY PACK FOR CINEMATOGRAPHY EQUIPMENT

(71) Applicant: Ross Kanarek, Plainview, NY (US)

(72) Inventor: Ross Kanarek, Plainview, NY (US)

(21) Appl. No.: 18/236,505

(22) Filed: Aug. 22, 2023

(51) Int. Cl. H01M 10/48

(52) U.S. Cl. CPC H01M 10/488; H01M 2220/30

(57) ABSTRACT

A cinematography battery pack includes a cinematography battery. The cinematography battery is configured to provide electrical power to audiovisual equipment. A light array includes a number of lights. The lights of the light array are arranged to display battery data for the cinematography battery. A battery pack housing holds the cinematography battery and the light array. At least a portion of the battery pack housing is translucent. The translucent portion of the battery pack housing is aligned with the light array to allow the battery data for the cinematography battery displayed by the lights of the light array to be visualized from outside the battery pack housing.

### FIELD

The present disclosure relates to a battery pack and, more particularly, to battery pack for cinematography equipment.

### BACKGROUND

Battery packs employed for powering audiovisual equipment, such as cameras, are often changed frequently. The frequent changes of such battery packs can result in battery packs being dropped or damaged, particularly in a fast paced filming environment, such as a production set. As an example, liquid crystal display (LCD) screens included in battery packs and employed to display battery pack data are susceptible to breakage as a result of the battery packs being dropped.

### SUMMARY

Battery packs, such as on-board battery packs used to connect directly with cinematography cameras tend to be thrown around on a production set and can therefore be susceptible to breakage. As an example, many battery packs for cinematography equipment include liquid crystal display (LCD) screens to display battery pack data, such as estimate run time, battery percentage, or charge time for the battery pack. However, the LCD screens are particularly susceptible to breakage as a result of the battery packs being frequently changed and dropped in a fast paced filming environment. The present inventive concept provides a highly durable display that can communicate battery data without the use of an LCD screen.

Embodiments of the present inventive concept provide a light emitting diode (LED) array that displays battery data (e.g., battery life or charging data) through an injection molded (e.g., ABS) or a polycarbonate case. The LED array can convey the same data as an LCD screen, but rather than turning on pixels of the LCD screen, various patterns of LEDs of the LED array are illuminated to display battery data. By embedding the LED array within a highly durable translucent battery pack housing, the LED array is position in a protected manner such that the display created by the LED array is virtually shatter proof, while still allowing symbols and alphanumeric characters to be displayed by the LED array and through the battery pack housing.

Provided in accordance with aspects of the present disclosure is a cinematography battery pack including a cinematography battery. The cinematography battery is configured to provide electrical power to audiovisual equipment. A light array includes a number of lights. The lights of the light array are arranged to display battery data for the cinematography battery. A battery pack housing holds the cinematography battery and the light array. At least a portion of the battery pack housing is translucent. The translucent portion of the battery pack housing is aligned with the light array to allow the battery data for the cinematography battery displayed by the lights of the light array to be visualized from outside the battery pack housing.

In an aspect of the present disclosure, a mask layer is arranged between the light array and the battery pack housing. The mask layer includes a number of apertures. The apertures are aligned with corresponding lights of the light array.

In an aspect of the present disclosure, the mask layer includes a pliable material.

In an aspect of the present disclosure, the mask layer includes rubber, plastic, or silicone.

In an aspect of the present disclosure, at least some lights of the light array are configured to be independently activated and deactivated to display the battery data for the cinematography battery.

In an aspect of the present disclosure, the battery pack housing defines a side surface. The lights of the light array extend diagonally with respect to the side surface of the battery pack housing.

In an aspect of the present disclosure, the lights of the light array are light emitting diodes.

In an aspect of the present disclosure, the lights of the light array are configured to emit white light or colored light.

In an aspect of the present disclosure, the cinematography battery is rechargeable.

In an aspect of the present disclosure, the cinematography battery includes a number of interconnected batteries.

In an aspect of the present disclosure, the cinematography battery is configured to output a first voltage and a second voltage different from the first voltage.

In an aspect of the present disclosure, the first voltage is about 14.4 volts, and the second voltage is about 28.8 volts.

In an aspect of the present disclosure, the cinematography battery is configured to switch between a first state having a parallel cellular arrangement, and a second state having a series cellular arrangement.

In an aspect of the present disclosure, the cinematography battery pack includes a resistor sense contact or a magnet switch. Each of the resistor sense contact and the magnet switch is configured to switch the cinematography battery between the first state and the second state.

In an aspect of the present disclosure, the cinematography battery is configured to charge a light, a camera, or a monitor.

In an aspect of the present disclosure, a battery mount plate is arranged on the battery pack housing. The battery mount plate includes a V-mount, a B-mount or a 3-stud mount battery connection.

In an aspect of the present disclosure, the battery data for the cinematography battery displayed by the lights of the light array include an estimated run time for the cinematography battery.

In an aspect of the present disclosure, the battery data for the cinematography battery displayed by the lights of the light array include an estimated percentage of battery life remaining for the cinematography battery.

In an aspect of the present disclosure, the battery data for the cinematography battery displayed by the lights of the light array include an estimated charge time for the cinematography battery.

In an aspect of the present disclosure, the light array includes a number of light emitting diodes arranged on a printed circuit board.

### BRIEF DESCRIPTION OF THE DRAWINGS

Various aspects and features of the present disclosure are described hereinbelow with reference to the drawings wherein:

FIG. 1 is a top, perspective view of a battery pack for cinematography equipment according to aspects of the present disclosure;

FIG. 2 is first top plan view of the interior of the battery pack for cinematography equipment of FIG. 1;

FIG. 3 is second top plan view of the interior of the battery pack for cinematography equipment of FIG. 1 including a mask layer arranged over the light array;

FIG. 4A illustrates a first exemplary embodiment of battery data displayed by the battery pack for cinematography equipment of FIG. 1;

FIG. 4B illustrates a second exemplary embodiment of battery data displayed by the battery pack for cinematography equipment of FIG. 1;

FIG. 4C illustrates a third exemplary embodiment of battery data displayed by the battery pack for cinematography equipment of FIG. 1;

FIG. 5 is a front view of the outside of the battery pack for cinematography equipment of FIG. 1 with battery data displayed;

FIG. 6 illustrates a first exemplary embodiment of a battery pack mount employable by the battery pack for cinematography equipment of FIG. 1;

FIG. 7 illustrates a second exemplary embodiment of a battery pack mount employable by the battery pack for cinematography equipment of FIG. 1;

FIG. 8 illustrates a third exemplary embodiment of a battery pack mount employable by the battery pack for cinematography equipment of FIG. 1;

FIG. 9 illustrates an exemplary embodiment of an LED array employable by the battery pack for cinematography equipment of FIG. 1; and

FIG. 10 illustrates an exemplary mask layer employable with the LED array of FIG. 9.

### DETAILED DESCRIPTION

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

Exemplary configurations of the disclosure will be described more fully below (e.g., with reference to the accompanying drawings). Like reference numerals may refer to like elements throughout the specification and drawings.

The phrases “battery mount,” “mount plate,” and “battery mount plate” may be used interchangeably herein. The phrases “battery,” “battery pack,” and “pack” may be used interchangeably herein.

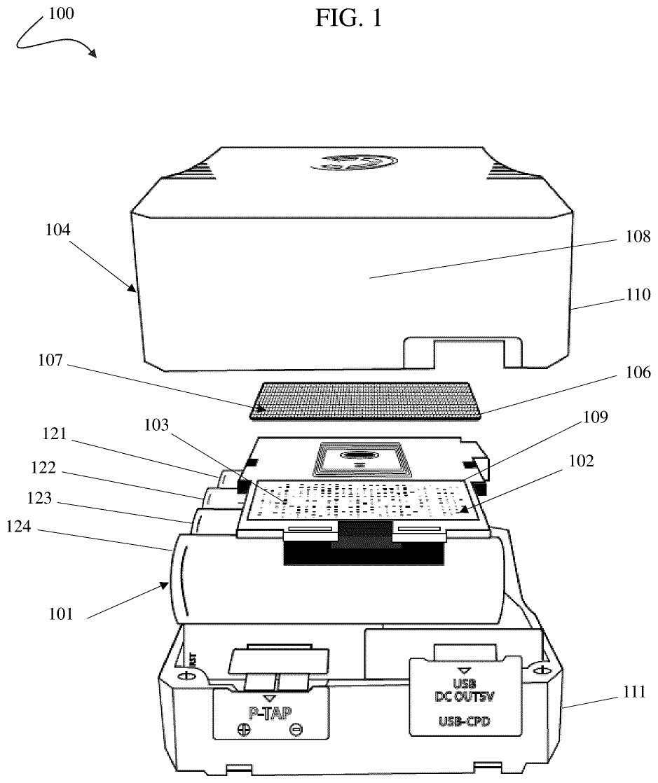

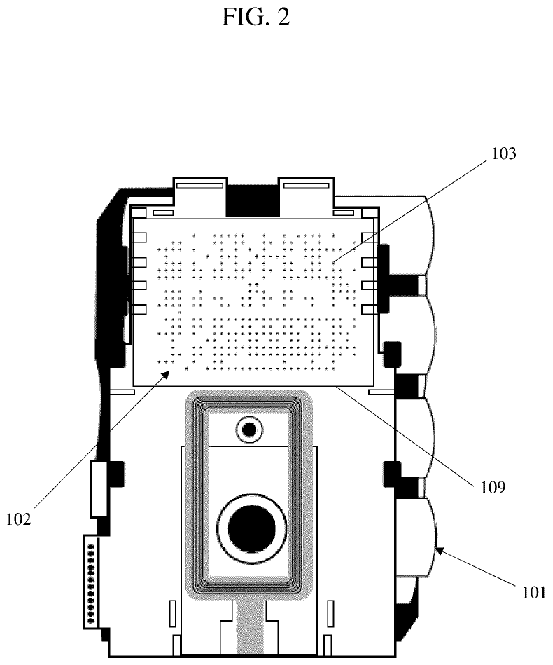

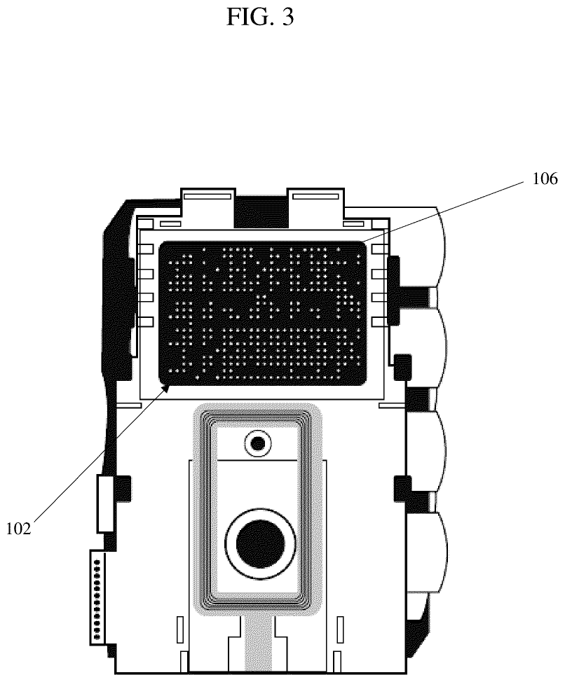

Referring to FIGS. 1 to 5, a cinematography battery pack 100 includes a cinematography battery 101. The cinematography battery 101 is configured to provide electrical power to audiovisual equipment, such as a camera (e.g., a camera configured for cinematography) employed for on-set filming in television and movie production. A light array 102 includes a number of lights 103. Each of the lights 103 may be a light emitting diode (LED). The lights 103 of the light array 102 are arranged to display battery data for the cinematography battery 101.

In use, a limited number of the total lights 103 of the light array 102 are illuminated to generate an image of alphanumeric characters and/or a symbol (e.g., a battery image with a number of bars indicating an amount of power filled in) to communicate data about the cinematography battery 101.

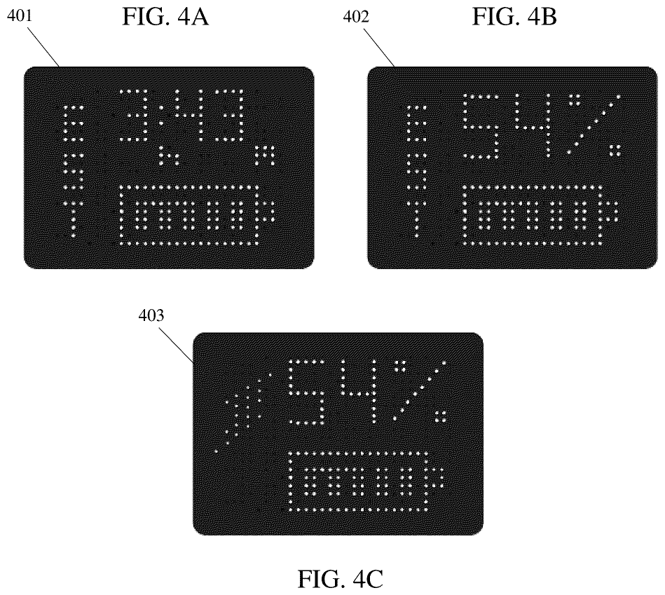

Referring particularly to FIG. 4A, the battery data for the cinematography battery 101 displayed by the lights 103 of the light array 102 may include an estimated run time for the cinematography battery 101.

Referring particularly to FIGS. 4B and 4C, the battery data for the cinematography battery 101 displayed by the lights 103 of the light array 102 include an estimated percentage of battery life remaining for the cinematography battery 101.

In an aspect of the present disclosure, the battery data for the cinematography battery 101 displayed by the lights 103 of the light array 102 include an estimated charge time for the cinematography battery 101.

Referring again to FIGS. 1 to 5, a battery pack housing 104 supports and houses the cinematography battery 101 and the light array 102. As an example, the battery pack housing 104 may be a single integrally formed structure, or the battery pack housing 104 may include two or more separable housings that can be removably coupled with each other. For example, the battery pack housing 104 may include a front housing 110 and a rear housing 111 that can be removably coupled with each other.

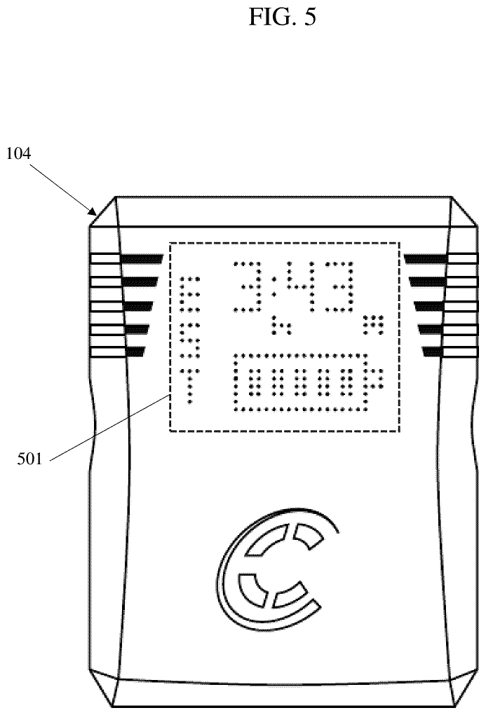

At least a portion of the battery pack housing 104 is translucent (see, e.g., translucent portion 501 in FIG. 5). The translucent portion of the battery pack housing 104 is aligned with the light array 102 to allow the battery data for the cinematography battery 101 displayed by the lights 103 of the light array 102 to be visualized from outside the battery pack housing 104. That is, the translucent portion of the battery pack housing 104 is sufficiently translucent that the light emitted by the lights 103 of the light array 102 can pass through the translucent portion of the battery pack housing 104. While only a portion of the battery pack housing 104 might be translucent and the other portions of the battery pack housing 104 might be opaque or substantially opaque, substantially the entire battery pack housing 104 might also be translucent.

The battery pack housing 104 may be formed of or include plastic, a polymer, any acrylic, a polycarbonate, a thermoplastic polymer, Acrylonitrile butadiene styrene (ABS), or any other suitable material that can incorporate a translucent portion adjacent the light array 102.

In use, the battery pack housing 104, and the arrangement of the light array 102 within the battery pack housing 104, prevents breakage of the lights 103, particularly when the cinematography battery pack 100 is transported, dropped, or in any way exposed to any sort of physical contact. That is, the battery pack housing 104 protects the light array 102, while allowing the light array 102 to display battery information for the pack.

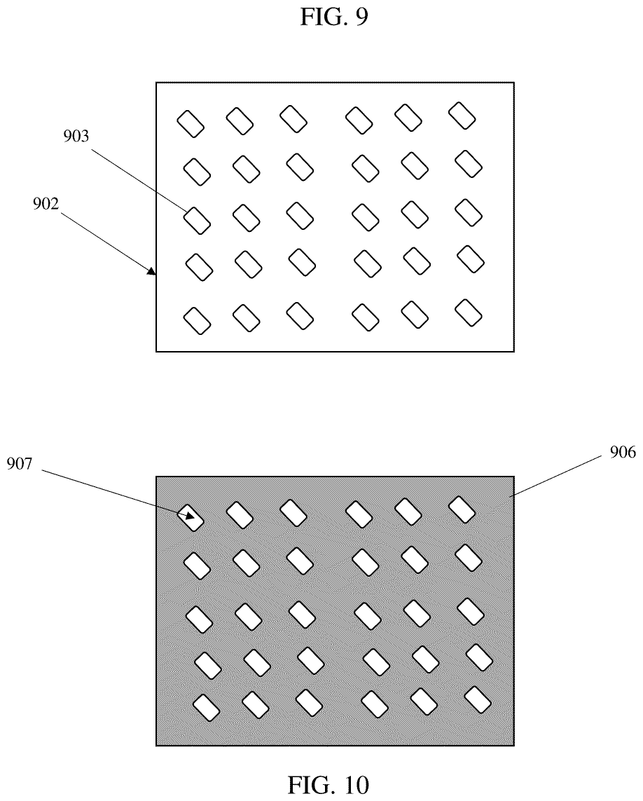

In an aspect of the present disclosure, a mask layer 106 is arranged between the light array 102 and the battery pack housing 104. The mask layer 106 includes a number of apertures 107. The apertures 107 are aligned with corresponding lights 103 of the light array 102. That is, each aperture 107 may be dimensioned, shaped, and positioned to receive a single light 103 of the light array 102 therein. An exemplary arrangement of the lights 103 and the apertures 107 is described in more detail below with reference to FIGS. 9 and 10.

In an aspect of the present disclosure, the mask layer 106 includes a pliable material, such as for example, rubber, plastic, or silicone.

In use, the mask layer 106 sharpens the resolution of the alphanumeric image and/or symbol(s) created by the lights 103 of the light array 102 by preventing blurring as a result of the light emitted from adjacent lights 103 bleeding together. The mask layer 106 also provides further protection to the lights 103 and prevents breakage of the lights 103. As an example, a thickness of the mask layer 106 may be substantially the same as the thickness of the lights 103, or the thickness of the mask layer 106 may be greater than the thickness of the lights 103. The mask layer 106 may directly contact an inner surface of the battery pack housing 104.

In an aspect of the present disclosure, at least some lights 103 of the light array 102 are configured to be independently activated and deactivated to display the battery data for the cinematography battery 101. As an example, each light 103 may be independently controllable by a microcontroller unit (MCU) arranged in the battery pack housing 104. The MCU is described in more detail below.

The lights 103 of the light array 102 may be consistently evenly spaced apart from each other throughout the light array 102, or at least some of the lights 103 may be relatively closer together or relatively further apart so that more or less lights 103 are arranged in different portions of the light array 102.

In an aspect of the present disclosure, the lights 103 of the light array 102 are configured to emit white light or colored light.

Referring to the cinematography battery 101, the cinematography battery 101 may be a rechargeable battery. As an example, the cinematography battery 101 may include numerous interconnected batteries (see, e.g., batteries 121, 122, 123 and/or 124).

In an aspect of the present disclosure, the cinematography battery 101 is configured to charge and/or power a light, a camera, or a monitor.

The cinematography battery 101 can be employed to power the light array 102. The cinematography battery 101 may be electrically connected with the light array 102, such as through a wired connection or a number of wired connections. Alternatively, the light array 102 can be powered by a separate battery.

In an aspect of the present disclosure, the cinematography battery pack 100 may be a dual voltage battery pack. That is, the cinematography battery 101 may be configured to output a first voltage and a second voltage different from the first voltage.

As an example, the first voltage is about 14.4 volts, and the second voltage is about 28.8 volts.

As an example, the cinematography battery 101 is configured to switch between a first state having a parallel cellular arrangement, and a second state having a series cellular arrangement.

An exemplary switching circuit is described in U.S. Pat. No. 10,630,095, the entire contents of which are incorporated by reference herein.

In an aspect of the present disclosure, the cinematography battery pack 100 includes a resistor sense contact or a magnet switch. Each of the resistor sense contact and the magnet switch is configured to switch the cinematography battery 101 between the first state and the second state.

Dual voltage battery packs are described in U.S. patent application Ser. No. 17/902,347, the entire contents of which are incorporated by reference herein, and U.S. patent application Ser. No. 17/970,283, the entire contents of which are incorporated by reference herein.

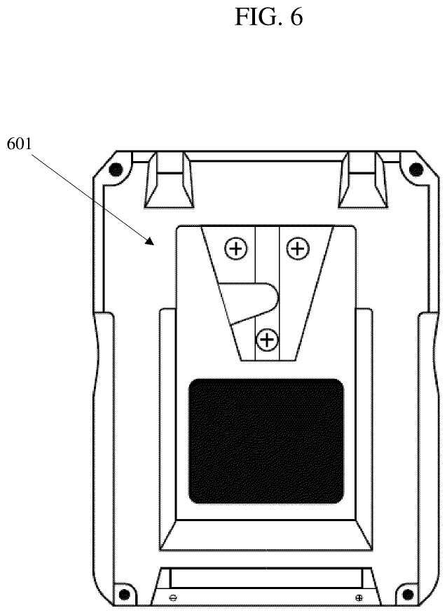

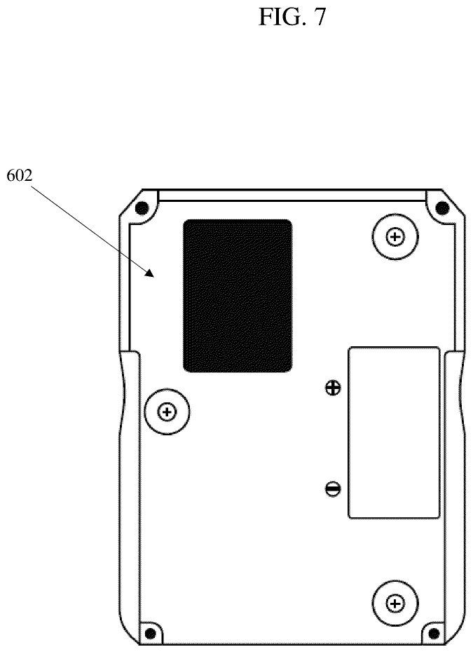

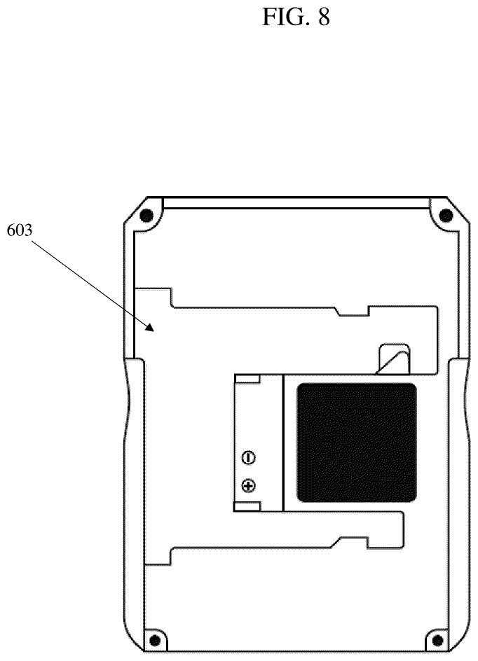

Referring to FIGS. 6-8, a battery mount plate (e.g., battery mount plates 601, 602, or 603) is arranged on the battery pack housing. The battery mount plate includes a V-mount, a G-mount, a B-mount or a 3-stud mount battery connection.

The battery mount plates may be in the form of various battery mount arrangements, such as V-mount, G-mount, B-mount, or other arrangements. Mount plates having different mounting arrangements for connecting with different types of batteries is described in U.S. Pat. No. 10,197,630, the entire contents of which are incorporated by reference herein. A mount plate having various features is described in U.S. Pat. No. 10,841,492, the entire contents of which are incorporated by reference herein.

FIG. 9 illustrates an exemplary embodiment of an LED array 902 including a number of lights 903 employable by the cinematography battery pack 100, and FIG. 10 illustrates an exemplary mask layer 906 including apertures 907 employable with the LED array 902 of FIG. 9.

Referring particularly to FIGS. 1-3, 9, and 10, the battery pack housing 104 defines a side surface 108. The lights 903 of the light array 902 extend diagonally with respect to the side surface 108 of the battery pack housing 104. Similarly, the apertures 907 of the mask layer 906 extend diagonally and are dimensioned, shaped, and positioned to receive corresponding lights 903 therein. As an example, each of the lights 903 and apertures 907 may extend at about a 45 degree angle with respect to the side surface 108 of the battery pack housing 104.

Referring particularly to FIGS. 1-3, the light array 102 may include a number of light emitting diodes (LEDs) arranged on a printed circuit board (PCB) 109. Each of the lights 103 may be controlled by an MCU in communication with the lights of the PCB.

The MCU may include one or more CPUs (processor cores), a memory, RAM, and programmable input/output peripherals. Program memory in the form of ferroelectric RAM, NOR flash or OTP ROM may be included in the MCU.

It will be understood that various modifications may be made to the aspects and features disclosed herein. Therefore, the above description should not be construed as limiting, but merely as exemplifications of various aspects and features. Those skilled in the art will envision other modifications within the scope and spirit of the claims appended thereto.

1. Audiovisual equipment, comprising:
at least one cinematography battery, wherein the at least one cinematography battery is configured to provide electrical power to the audiovisual equipment;
a light array including a plurality of lights, wherein the plurality of lights of the light array are arranged to display battery data for the at least one cinematography battery, wherein the plurality of lights of the light array are configured to display alphanumeric characters to communicate the battery data for the at least one cinematography battery;
a battery pack housing configured to hold the at least one cinematography battery and the light array;
a translucent portion integrally defined in the battery pack housing, wherein the translucent portion of the battery pack housing is aligned with the light array to allow the battery data for the at least one cinematography battery displayed by the plurality of lights of the light array to be visualized from outside the battery pack housing; and
a battery mount plate supported by the battery pack housing, wherein the battery mount plate is configured to removably couple the battery pack housing with the audiovisual equipment.

2. The audiovisual equipment of claim 1, wherein the at least one cinematography battery further includes at least one mask layer arranged between the light array and the battery pack housing, wherein the at least one mask layer includes a plurality of apertures defined therein, wherein the apertures of the plurality of apertures are aligned with corresponding lights of the plurality of lights.

3. The audiovisual equipment of claim 2, wherein the at least one mask layer includes a pliable material.

4. The audiovisual equipment of claim 3, wherein the at least one mask layer includes rubber, plastic, or silicone.

5. The audiovisual equipment of claim 1, wherein at least some lights of the plurality of lights are configured to be independently activated and deactivated to display the battery data for the at least one cinematography battery.

6. The audiovisual equipment of claim 1, wherein the battery pack housing defines at least one side surface, and wherein the lights of the plurality of lights extend diagonally with respect to the at least one side surface of the battery pack housing.

7. The audiovisual equipment of claim 1, wherein the lights of the plurality of lights are light emitting diodes.

8. The audiovisual equipment of claim 1, wherein the lights of the plurality of lights are configured to emit white light or colored light.

9. The audiovisual equipment of claim 1, wherein the at least one cinematography battery is rechargeable.

10. The audiovisual equipment of claim 1, wherein the at least one cinematography battery includes a plurality of interconnected batteries.

11. The audiovisual equipment of claim 1, wherein the at least one cinematography battery is configured to output at least one first voltage and at least one second voltage different from the at least one first voltage.

12. The audiovisual equipment of claim 11, wherein the at least one first voltage is about 14.4 volts, and wherein the at least one second voltage is about 28.8 volts.

13. The audiovisual equipment of claim 1, wherein the at least one cinematography battery is configured to switch between a first state having a parallel cellular arrangement, and a second state having a series cellular arrangement.

14. The audiovisual equipment of claim 13, further including a resistor sense contact or a magnet switch, wherein each of the resistor sense contact and the magnet switch is configured to switch the at least one cinematography battery between the first state and the second state.

15. The audiovisual equipment of claim 1, wherein the at least one cinematography battery is configured to charge a light, a camera, or a monitor.

16. (canceled)

17. The audiovisual equipment of claim 1, wherein the battery data for the at least one cinematography battery displayed by the plurality of lights of the light array includes an estimated run time for the at least one cinematography battery.

18. The audiovisual equipment of claim 1, wherein the battery data for the at least one cinematography battery displayed by the plurality of lights of the light array includes an estimated percentage of battery life remaining for the at least one cinematography battery.

19. The audiovisual equipment of claim 1, wherein the battery data for the at least one cinematography battery displayed by the plurality of lights of the light array includes an estimated charge time for the at least one cinematography battery.

20. The audiovisual equipment of claim 1, wherein the light array includes a plurality of light emitting diodes arranged on a printed circuit board.

21. (canceled)
